(19) United States
(12) Patent Application Publication
(10) Pub. No.: US 2007/0299895 A1
(43) Pub. Date: Dec. 27, 2007

(54) System and method of generating electrical stimulation waveforms as a therapeutic modality

(76) Inventors: Scot L. Johnson, Lutz, FL (US); Andrew DeWeerd, Clearwater, FL (US)

Correspondence Address: MCANDREWS HELD & MALLOY, LTD, 500 WEST MADISON STREET, SUITE 3400, CHICAGO, IL, 60661, US

(21) Appl. No.: 11/811,485

(22) Filed: Jun. 11, 2007

Related U.S. Application Data
(60) Provisional application No. 60/812,486, filed on Jun. 9, 2006.

(51) Int. Cl. G06F 1/02

(52) U.S. Cl. 708/270

(57) ABSTRACT

Embodiments of the present invention provide an apparatus and method of generating electrical stimulation waveforms using Direct Digital Synthesis (DDS). The waveform generation substantially reduces intensive processor calculations and commands required for the generation of waveforms via Pulse Width Modulation (PWM). DDS technology is integrated into single-integrated circuit components, capable of generating waveforms based on singular digital word commands. The use of DDS integrated circuits allows for rapid changes in frequencies, automatically sweeps frequencies between user defined limits, and are capable of a wide range of frequencies. Further, utilization of DDS in waveform generation allows for software updatable functionality. Additionally, because DDS technology outputs a smooth sine wave, the need for extensive filtering is drastically reduced. Further, DDS technology can be utilized in an amplitude modulation stage beyond the DDS waveform generator, further reducing the burden on processor systems.

### RELATED APPLICATION

This application claims the benefit of U.S. Provisional Application No. 60/812,486, filed Jun. 9, 2006, which is incorporated herein by reference in its entirety.

### BACKGROUND OF THE INVENTION

Embodiments of the present invention generally relate to a system and method of generating electrical stimulation waveforms, and more particularly to a method of generating electrical stimulation waveforms using Direct Digital Synthesis (DDS).

Electrical stimulation has been utilized and refined for decades as a means to activate and strengthen muscle, improve circulation, reduce edema and inflammation, reduce pain, and to fatigue muscle so as to reduce muscle spasm and tremors. The type of waveform utilized has been evolved for decades in medical practice, as has the technology used to produce it. Constant current (DC or galvanic current), pulsed Monophasic (uni-directional), Biphasic (bi-directional) waveforms (including square, triangle, trapezoidal, and sine wave), and asymmetrical and symmetrical waveforms have all been investigated.

Recent systems incorporate interferential therapy (Bipolar and Quadripolar). Basic forms of electrical stimulation devices (e.g. TENS or non-Interferential) produce frequencies generally ranging from 0 to 250 Hz influencing cellular functions. These systems are limited by the impedance of the skin. Higher power (dosage) levels applied in an effort to produce a more profound effect at deeper tissue levels reach a limit whereby skin tissue is damaged or destroyed. More current systems may modulate the amplitude of a carrier frequency (above 2000 Hz) between 0 and 250 Hz (Amplitude Modulation or AM). These systems may also frequency-modulate the same carrier frequency between 0 and 250 Hz and greater to achieve a similar effect. These systems transmit the 0 to 250 Hz signal deeper into the body, as the impedance of the skin is frequency-dependent, and carrier frequencies above 2000 Hz allow significantly higher power levels (dosage) to reach deeper level tissues safely (higher frequencies produce lower skin impedance). Interferential systems produce two carrier frequencies of slightly different frequency to produce an interference pattern affecting very deep tissue. The differences in the two carrier frequencies are typically between 0 and 250 Hz.

The generation of these waveforms has progressed from completely analog discrete component systems to processor-based Pulse Width Modulated (PWM) systems. Purely analog systems incorporated complex Resistor-Inductor-Capacitor (RLC) circuitry configured as an oscillator, resulting in a single-frequency waveform. Analog controls on the instrument allowed the user in some cases to tune the oscillator, adjusting the frequency. Several such oscillators, gain and filter loops, and transformer circuits produced the stimulation. But purely analog systems require calibration, are not software updatable, can not store complex series of waveform treatments, and can not “remember” individual patient settings. Further, healthcare providers require training to manipulate the units to produce successful treatments. Analog systems also are temperature dependent, as the waveform may be slightly changed by changes in temperature.

Technological advancements have led to processor-based systems capable of utilizing more modern methods of waveform generation, including the PWM model. In this model, a processor streams out a digital data stream of ones and zeros. This data stream is led through an analog filter, which converts the data stream into a waveform. The duration of the on-time (time the processor holds a “1” value, typically at a low-voltage level) increases the charge within the analog filter. The one value is then dropped to zero for a finite period of time, and again is raised to a “1” value. A sine wave can be imagined as the processor pulsing a “1” value for a short period of time initially, then dropped to zero and pulsed again to a “1” for a longer period of time. This increasing cycle of holding the “1” value reaches a maximum level, and the cycle is then reduced similarly. The name Pulse Width Modulation (PWM) is derived from the fact that the length of time the processor holds the “1” value is the width of the pulse. The output from the filter is a sine wave composed of a series of small steps up and then down. This type of system is limited by a number of variables. First, the processor must produce as quickly as possible the data stream of ones and zeros. The more information the processor can feed into the analog filter, the smoother the waveform.

But the PWM system is extremely processor intensive, particularly if the system provides more than one channel of therapy. Further, because of the nature of the analog filter, every time the pulse is changed from a “1” to a “0”, or vice versa, the filter outputs a spectrum of unwanted noise which requires filtering. The limitations of the conversion process in terms of waveform stepping and the additional noise created requires the system to aggressively filter the signal to achieve as smooth a sine wave as possible for delivery to the patient. Additionally, these systems typically require calibration, and are not generally software upgradeable. Any new developments in the technology in terms of medically approved waveforms require new circuitry. Limitations of the system are typically evidenced by the fact that only discrete carrier (high frequency) and either Amplitude or Frequency modulated pulsing (lower frequency, between 0 and 250 Hz) are selectable. This is due to favored regions of operation within the circuitry. Amplitude Modulation (AM) may be applied to a continuous or changing carrier frequency, the change in amplitude affecting the 0 to 250 Hz signal which affects the tissues biologically. Frequency Modulation (FM) does not require amplitude modulation, but rather relies on the frequency dependent impedance of the skin. FM typically holds either the voltage or current of the waveform constant, and allows the other to drift as frequency changes. As the carrier frequency increases and decreases, the impedance decreases and increases, respectively. Correspondingly, the overall intensity that is affected by the waveform decreases and increases respectively. The affect, when modulated between 0 and 250 Hz, is the same utilizing either AM or FM.

Some systems may utilize one or more gain loops (operational amplifiers) to increase and decrease the amplitude of the sine waveform. In a PWM system, the waveform is generated and filtered extensively, then fed through a gain control loop, through a step-up transformer, and finally to the patient. The gain loop increases and decreases the amplitude of the waveform to an acceptable level for input into the transformer. It is also responsible for any AM features of the waveform. In some systems several gain loops with discrete settings provide a selectable set of discrete amplitudes. In other systems, a potentiometer is controlled manually by the healthcare provider via an external control that increases and decreases resistance within the gain loop correspondingly changing the amplitude of the waveform. In more advanced systems, digital potentiometers are controlled by the processor, allowing the amplitude to be increased or decreased automatically. As with PWM, the use of digital potentiometers, while allowing for tighter control of amplitude, requires a great deal of processor power. If a PWM system is to modulate amplitude up and down at some frequency between 0 and 250 Hz, the processor of that system must continuously write to the digital potentiometers.

This burden, along with the continuous PWM signal itself, becomes a severe limit to the system's performance and capabilities. Often, at higher carrier frequencies and higher amplitude modulation rates, the output waveform exhibits irregularities, either in larger steps in the PWM output signal or in the stepping observed in the amplitude modulation. Because of this limitation, designers may elect to implement FM, focusing on the generation of a PWM signal to control carrier frequency changes.

If the sine wave delivered to the patient is not smooth, as in the case of excessive stepping, the patient may feel discomfort. This discomfort may take the form of a scratching, irregular feeling beneath and/or about the electrodes. This discomfort may limit the dosage that can be comfortably applied to a patient. It also may affect the patient's willingness to undergo the therapy. In many applications of electrical stimulation, the dosage must be increased to at least a minimum level to be effective.

### SUMMARY OF THE INVENTION

Embodiments of the present invention may utilize DDS technology as a waveform generator for electrical stimulation. DDS technology can be broken down into an amalgam of subsystems. A DDS integrated circuit utilizes power and digital commands from a processor. Those digital commands are typically in the form of a digital “word,” a series of ones and zeros that are received in either series or in parallel. The digital word is interpreted as a frequency.

The DDS contains a table of values that represent a sinusoidal waveform. DDS technology is capable of producing frequencies from 0 to over 100 kHz easily and smoothly. The technology may use a single digital word command to produce a sine wave at a frequency for as long as a treatment requires, doing so until a new command is issued. This feature removes the constant burden of waveform generation from a processor, allowing the system to spend more time analyzing the treatment and adjusting parameters as required.

DDS technology outputs a nearly smooth sinusoidal waveform that is easily filtered for smoothness, unlike the PWM technology previously described which utilizes comprehensive filtering. The smooth sinusoidal representation typically includes at least 256 values at the frequency specified by the digital word Additionally, DDS technology typically integrates frequency sweep commands such that the processor may define a center frequency and a sweep range and allow the DDS integrated circuit to sweep the waveform (FM) automatically. Some DDS integrated circuits also include amplitude control, such that the processor could issue a command to specify alternating the amplitude of the output sine wave between and minimum and maximum value.

As the DDS is capable of a wide variety of automatic waveform manipulation controlled by a few simple commands from a processor, the system is easily upgraded via software. A software upgrade could include a new set of commands that the processor would issue to change the frequency limits of an earlier DDS system, for example from 4000 to 10000 Hz, to 4000 to 100 kHz instantly. Further, software upgrades could allow for expansion as new waveforms are approved for medical use.

While some DDS technology can also manipulate amplitude, the range of the amplitude may not be sufficient for electrical stimulation therapy. A more robust design would route the output of the DDS directly through a filter, into a gain control circuit, through a step-up transformer, and directly to the patient. As described earlier, digital potentiometers within the gain control loop can be written continuously by the processor to control amplitude modulation. This process is made easier by the fact that the DDS requires only minimal processor communications.

Embodiments of the present invention may include a second DDS circuit within the gain control loop. This second DDS circuit may receive a single command from the processor, for example to create a 250 Hz sine wave that could be used to control the gain control loop directly.

Optionally, the DDS might sweep between two values, for example between 0 and 250 Hz, thus sweeping the amplitude modulation. A single command to the carrier frequency generating DDS circuit and a single command to the amplitude modulating DDS circuit may be used to generate a waveform for the duration of the therapeutic treatment session.

Certain embodiments of the present invention include a system utilizing a processor, a DDS circuit, a filtering circuit, a gain loop including digital potentiometer(s), a step-up transformer, and an electrode pair for creating and delivering electrical stimulation to a patient. The processor issues digital words to the DDS circuit which delivers a smooth sine waveform output to the filtering circuit. The filtered waveform is delivered to a gain control loop that receives commands from the processor that change digital potentiometer values and adjust waveform amplitude. The amplitude adjusted waveform is fed through a step-up transformer whose output is fed through wires to electrodes placed onto the patient's body.

Other embodiments of the present invention include a system utilizing a processor, a DDS circuit, a filtering circuit, a gain loop including a DDS circuit, a step-up transformer, and an electrode pair for creating and delivering electrical stimulation to a patient. The processor issues digital words to the DDS circuit which delivers a smooth sine waveform output to the filtering circuit. The filtered waveform is delivered to a gain control loop that receives commands from the processor instructing a DDS circuit to automatically adjust waveform amplitude. The amplitude adjusted waveform is fed through a step-up transformer whose output is fed through wires to electrodes placed onto the patient's body.

### BRIEF DESCRIPTION OF SEVERAL VIEWS OF THE DRAWINGS

FIGS. 1a-d illustrate various examples of waveforms utilized by electrical stimulation to excite cellular function, namely a pulsed DC or square wave, a triangular wave, a sawtooth wave, and a sine wave, respectively.

FIGS. 2a-c illustrate examples of various waveforms applied during electrical simulation therapy, namely a low frequency sine wave, and a modulated (AM) high frequency sine wave.

FIGS. 3a-c illustrate a medium frequency amplitude modulated sine wave, a frequency modulated signal, and the effective sinusoidal current that is delivered to deeper tissues at higher current by the amplitude modulated signal and frequency modulated signal, respectively.

FIG. 4 illustrates Quadripolar Interferential therapy waveforms, wherein two crossing pure high-frequency sine waves are aligned such that at the center of the crossing an interference pattern is created, resulting in a waveform with low frequency characteristics.

FIGS. 5a-c illustrate three PWM signals of varying duty cycles.

FIG. 6 illustrates the output of an analog filter utilized in a PWM waveform generation system superimposed upon a perfect sine wave.

FIG. 7a illustrates a digital PWM signal with modulation.

FIG. 7b illustrates a sine wave corresponding to the PWM signal in FIG. 7a after the modulated PWM signal has passed through an analog filter.

FIG. 8a illustrates sine wave that has emerged from filtering stage as a monophasic waveform (uni-directional).

FIG. 8b illustrates the amplification stage of the sine wave from FIG. 8a, in which a negative and positive power source amplifies the signal and converts it to a biphasic waveform (bi-directional).

FIG. 8c illustrates the step-up transformer stage, wherein a transformer steps-up the voltage of the sine wave shown in FIG. 8b to a level appropriate for electrical stimulation before passing the sine waveform onto a patient's body.

FIG. 9 is a flowchart demonstrating a PWM system for electrical stimulation.

FIG. 10 is a flowchart demonstrating one embodiment of the present invention in which an electrical stimulation waveform generation circuit utilizes a DDS circuit to generate the waveform from a digital word.

FIG. 11 is a flowchart demonstrating one embodiment of the present invention utilizing a DDS circuit for wave generation and a DDS circuit to control the amplification circuit.

FIG. 12 is a flowchart demonstrating the inner workings of a DDS circuit.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

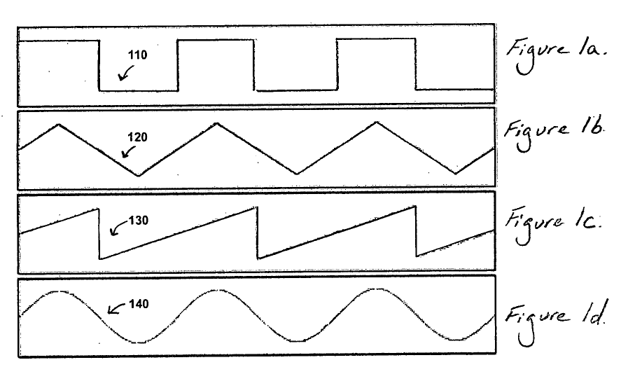

FIGS. 1a-d illustrate various examples of waveforms utilized by electrical stimulation to excite cellular function, namely a pulsed DC or square wave 110, a triangular wave 120, a sawtooth wave 130, and a sine wave 140, respectively. Each of the waveforms illustrated in FIGS. 1a-d is monophasic, wherein current is passed from one electrode on a patient's body to another electrode on the patient's body in only one direction. However, each of the waveforms illustrated in FIGS. 1a-b may be amplified to a biphasic state.

As shown by FIG. 1a, with a pulsed DC or square wave 110, the current that is passed from a one electrode to another may have a rapid ascent to a maximum level, where the current level may be held before being abruptly dropped down to a minimum level. With triangular waves 120, as shown in FIG. 1b, the current level passed from one electrode to another may be ramped up until reaching a maximum level, whereupon the current level may be ramped back down. A triangular wave 120 stimulation may be more comfortable for a patient than a pulsed DC or square wave 110, as the ramping up of the current to a maximum level may allow the patient periods of time to acclimate to the therapeutic current. Trapezoidal waves (not shown) ramp up the current passed from one electrode to another to a maximum level, then hold the current at the maximum level for a period of time, before the current is ramped back down to a minimum level. As with a triangular wave 120, the ramping up of current by the trapezoidal wave may also be more comfortable for a patient, as it too may allow the patient to acclimate to the therapeutic current. A sawtooth wave 130 stimulation, as illustrated by FIG. 1c, is a variant of triangular wave 120 stimulation. More specifically, the sawtooth wave 130 simulation ramps current up to a maximum level before abruptly dropping the current off to a minimum level. As shown in FIG. 1d, a sine wave 140 stimulation is a continuously applied current wherein the current smoothly increases and decreases according to sinusoidal calculations.

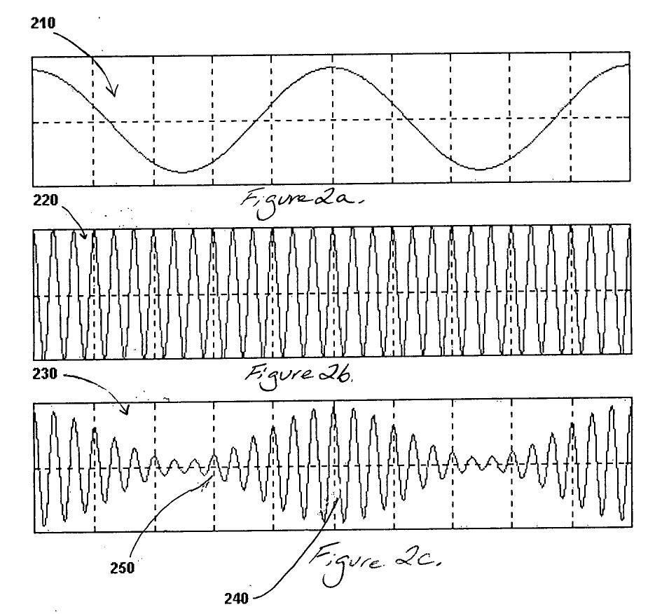

FIGS. 2a-c illustrate examples of various waveforms applied during electrical simulation therapy, namely a low frequency sine wave 210, a high frequency sine wave 220, and a modulated (AM) high frequency sine wave 230. The low frequency sine wave 210 shown in FIG. 1a may have a frequency between 0 and 250 Hz. This low frequency sine wave 210 constitutes the signal recognized as affecting cellular functions. Moreover, the low-frequency sine wave 210 is limited in its application by the fact that at lower frequencies, the impedance of the skin is high. As such, the low-frequency sine wave 210 is limited to current levels sufficiently low such that skin is not damaged or destroyed.

A high-frequency sine wave 220, as shown in FIG. 2b, may have a frequency greater than 2000 Hz. The high-frequency sine wave 220 passes through the skin tissues more easily because as frequency increases, the skin impedance decreases.

The amplitude modulated (AM) high frequency sine wave 230 shown in FIG. 2c is a combination of the low-frequency sine wave 210 and the high-frequency sine wave 220. This form of simulation, which is also referred to as Medium Frequency or Bipolar Interferential, overcomes the frequency-dependent skin-impedance limitations of low-frequency waveforms. In particular, an AM circuit “mixes” the low-frequency sine wave 210 and the high-frequency sine wave 220, multiplying the two frequencies mathematically, such that a high-frequency AM sine wave 230 emerges. The high-frequency AM sine wave 230 has both the cell function affecting characteristics of the low frequency sine wave 210 and is subject to the lowered frequency-dependent skin impedance characteristic of the high frequency sine wave 220. The high frequency waveform of the AM signal 230 is called the carrier frequency 240. The low frequency waveform of the AM signal 230 is referred to as the envelope frequency 250. This type of waveform 230 is generated within the electrical stimulation device before being delivered to the patient. The AM signal waveform 230 is sometimes referred to as “Medium Frequency” or “Bipolar Interferential” stimulation.

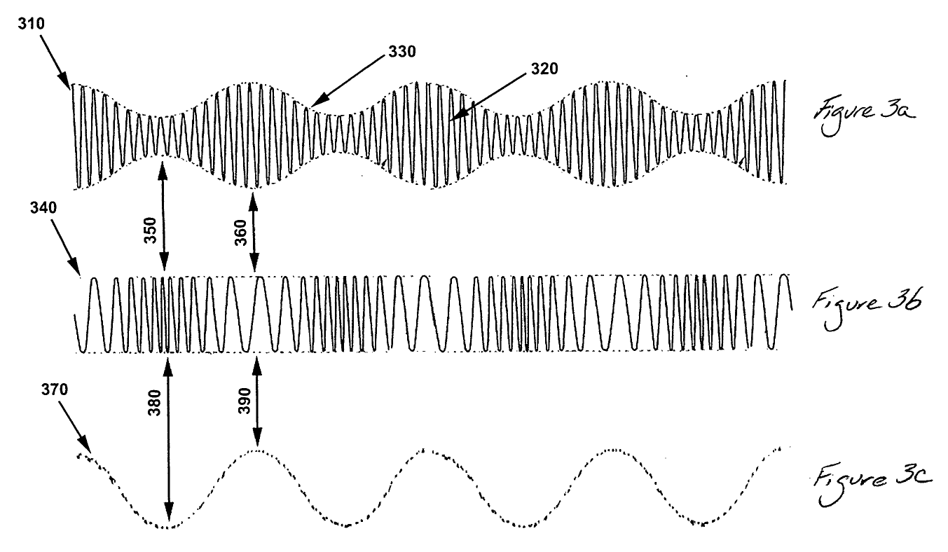

FIGS. 3a-c illustrate a medium frequency amplitude modulated sine wave 310, a frequency modulated signal 340, and the effective sinusoidal current 370 that is delivered to deeper tissues at higher current by the amplitude modulated signal 310 and frequency modulated signal 340.

The modulated carrier frequencies in FIGS. 3a and 3b are aligned with respect to the low frequency sine wave in FIG. 3c to illustrate how either of the modulated carrier frequencies affect the body's tissues, respectively. The medium frequency amplitude modulated sine wave 310 is capable of passing through the skin at relatively higher current than a low frequency waveform without damaging skin tissue. The medium frequency signal 310 demonstrates a high frequency sine wave component, also called the carrier frequency 320. The carrier frequency 320 is amplitude modulated by a lower frequency sine wave of between 0 and 250 Hz, as is demonstrated by the envelope frequency 330.

FIG. 3b demonstrates a frequency modulated (FM) signal 340. The FM signal 340 is a high frequency sine wave (>2000 Hz) that is capable of passing through the skin at relatively higher current than a low frequency sine wave. The FM signal 340 consists of a carrier wave that is frequency modulated anywhere from 0 to 250 Hz, as this frequency range has been shown to affect cellular function. For example, an FM signal 340 of 4000 Hz intended to affect cellular function at a frequency of 250 Hz would be generated such that the FM signal 340 would sinusoidally increase and decrease frequency from 4000 to 4250 Hz. This FM signal 340 affects cellular function because current set at the 4000 Hz level may feel less intense at 4250 Hz due to the lowered impedance of the skin at that higher frequency 350. As the FM signal 340 increases in frequency towards 4250 Hz, the current may feel less intense, due to decreasing skin impedance. As the FM signal 340 decreases in frequency back to 4000 Hz, or lower frequency 360, the current may feel more intense, due to increasing skin impedance. This sinusoidal increase 360 and decrease 350 of current intensity affects cellular function similarly to an AM signal 310.

FIG. 3c demonstrates the effective sinusoidal current 370 that is delivered to deeper tissues at higher current by the AM signal 310 and FM signal 340. The AM signal 310 and FM signal 340 are designed such that the delivery of low frequency sine wave 370 stimulation is delivered beyond the skin tissue safely.

When either the amplitude of the AM signal 310 is decreased or the frequency of the FM signal 340 is increased to a higher frequency 350, the cells at the deeper tissues experience the lower portion 380 of the therapeutic 0 to 250 Hz sine wave 370 stimulation. When either the amplitude of the AM signal 310 is increased or the frequency of the FM signal 340 is decreased to the lower frequency 360, the cells at the deeper tissues experience the upper portion 390 of the therapeutic 0 to 250 Hz sine wave 370 stimulation. The resultant low frequency sine wave 370 affecting cellular function is referred to as the “beat frequency” and is sometimes measured as pulses per second or PPS.

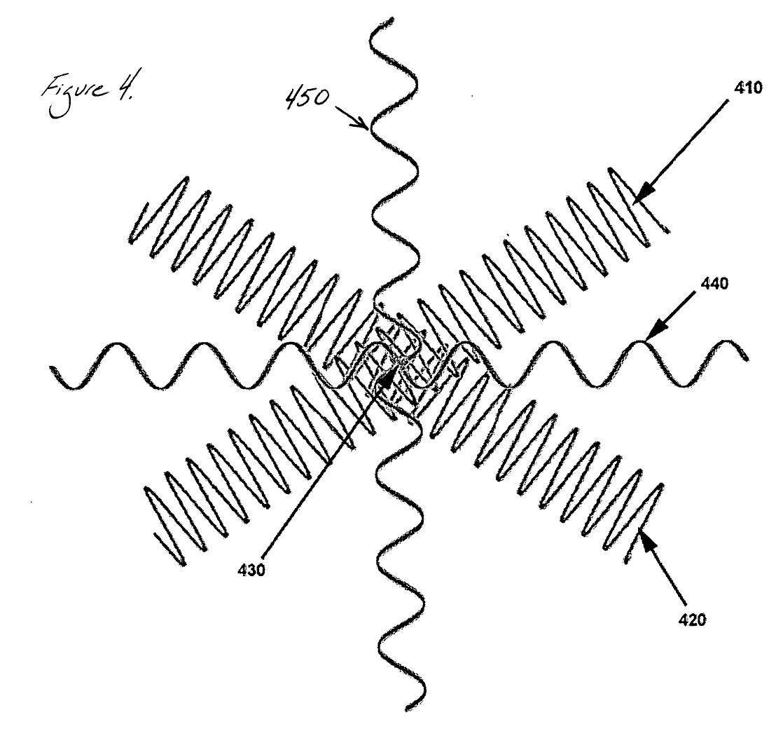

FIG. 4 illustrates Quadripolar Interferential therapy waveforms, wherein two crossing pure high-frequency sine waves 410, 420 are aligned such that at the center of the crossing 430 an interference pattern is created, resulting in a waveform incorporating low-frequency characteristics 440, 450. Quadripolar Interferential therapy waveforms may be generated by at least four electrodes. In a basic application, two electrodes generate a first high frequency sine wave 410 greater than 2000 Hz. A second pair of electrodes generate a second high frequency sine wave 420 of a slightly lower or higher frequency than the first high frequency sine wave 410. Arrangement of the electrode pairs in a crosswise pattern causes the first and second sine waves 410, 420 to interfere within the tissues wherever both waveforms are present, such as at the crossing 430. The low frequency characteristic of the resultant waveform 440, 450 is referred to as the “beat frequency” and is sometimes measured as pulses per second or PPS. For example, if the first high frequency sine wave 410 is at 4000 Hz, and the second high frequency sine wave 420 is at 4250 Hz, the difference frequency of the interference waveform 440, 450 is at 250 Hz.

This type of electrical stimulation has the advantage of being able to transmit higher current through the skin because of the skin's lowered impedance at higher frequencies of the sine waves 410, 420. Whereas with AM or FM modulated medium frequencies the waveforms are created within the electrical stimulation device itself before being delivered to the patient, Quadripolar Interferential stimulation generates pure sine waves 410, 420 only, the resultant beat frequency, being developed within the patient body itself wherever both high frequency sine waveforms 410, 420 interfere.

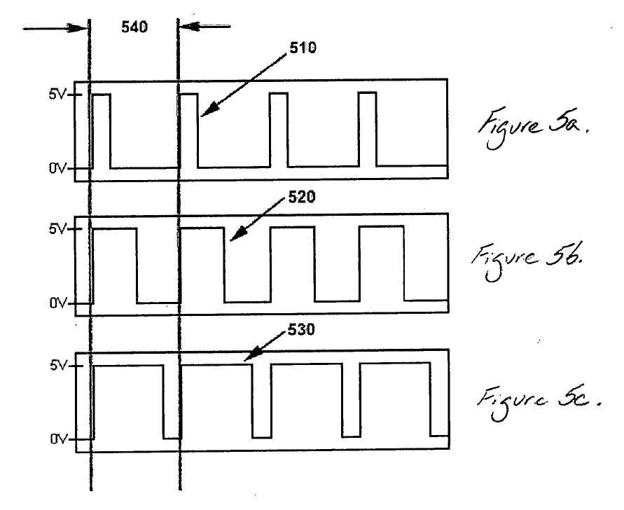

FIGS. 5a-c illustrate three PWM signals of varying duty cycles. A PWM signal is generated by a processor circuit and is a digital stream of essentially 1's and 0's. Wherever the signal is a “1”, the signal is said to be a high signal 510, 520, 530. This high signal 510, 520, 530 is a set voltage, typically at five volts or less. Where the signal is a “0”, the signal is said to be low. The low signal voltage is typically at or near zero volts.

PWM signals are delivered to an analog filtering circuit at a constant frequency 540. The duty cycle of the signal, i.e., the time between pulses where the signal is high, dictates the output of the analog filter. In electrical stimulation therapy, generating a sine wave would entail gradually increasing and decreasing the duty cycle of the PWM signal such that the output of the analog filter is a continuous function that approximates a sine wave by correspondingly gradually increasing and decreasing voltage. The output of the analog filter is monophasic, requires filtering, amplification, and finally transmission through a step-up transformer before being delivered to the patient. For example, a PWM signal of a constant frequency 540 is demonstrated in FIG. 5a at a 20% duty cycle, 50% duty cycle in FIG. 5b, and a 80% duty cycle in FIG. 5c. The gradually increasing duty cycles exemplified by FIGS. 5a-5c of the PWM signal would correspond to an increasing analog output from the analog filter.

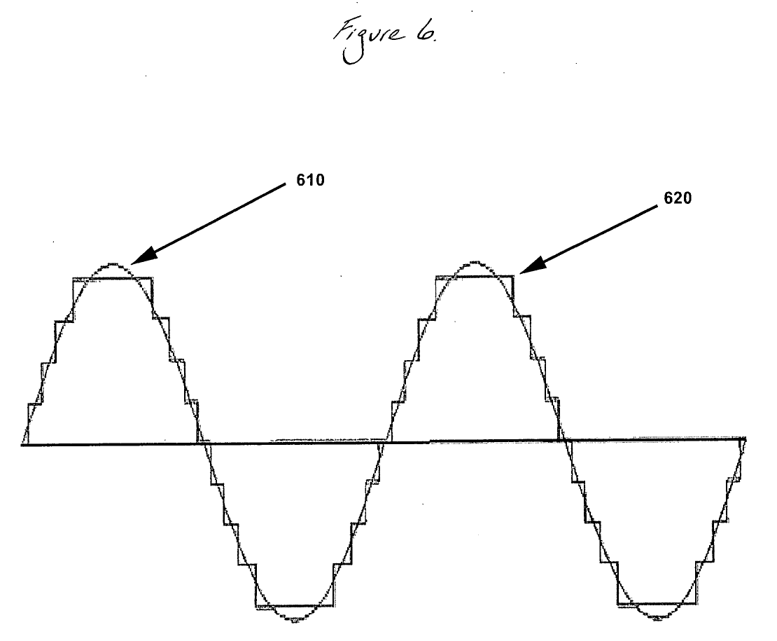

FIG. 6 illustrates a piece-wise signal resembling stair stepping superimposed upon a sine wave 610.

FIG. 6 illustrates the output of an analog filter utilized in a PWM waveform generation system superimposed upon a perfect sine wave 610. The output from an analog filter fed by a PWM signal approximates a sine wave, but is not perfect. In fact, the output is jagged, piece-wise, and is referred to as “stair stepping” 620. A stair stepping 620 waveform stimulation is undesirable for electrical stimulation therapy and requires smoothing through various filters before reaching the patient. Moreover, a stair-stepping simulation 620 is uncomfortable for the patient, and without filtering would limit both the patient's tolerance to increasing therapeutic current and the patient's perception of the therapy. Conversely, a perfect sine wave 610 may be the most comfortable form of electrical stimulation for the patient. Therefore, it is the goal of further filtering stages within the electrical stimulation device to smooth the jagged stair stepping 620 waveform into something closer to the perfect sine wave 610 before passing the signal on to an amplification stage.

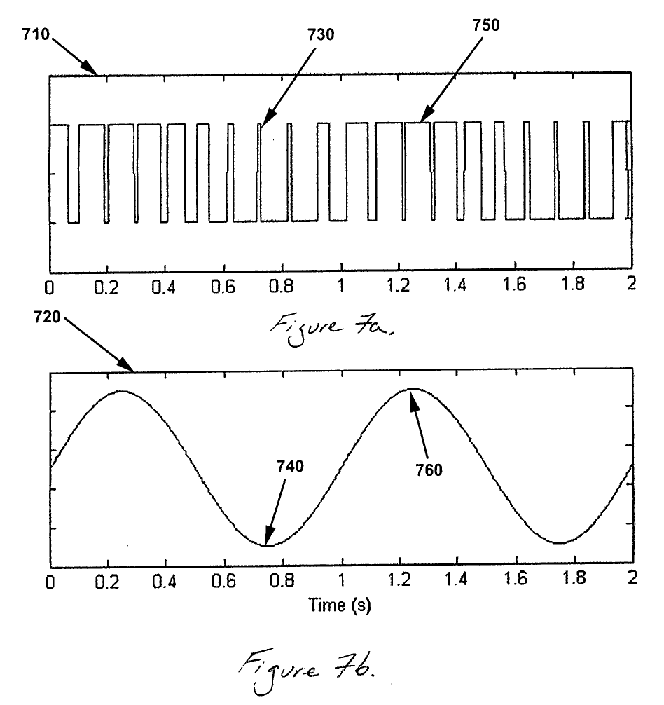

FIG. 7a illustrates a digital PWM signal 710 with modulation. The digital PWM signal 710 consists of a constant frequency pulse train with lower 730 and higher 750 duty cycles. FIG. 7b illustrates a sine wave 720 corresponding to the PWM signal 710 in FIG. 7a after the modulated digital PWM signal 710 has passed through an analog filter. Once the digital PWM signal 710 passes through an series of analog filter circuits, it appears as an approximation of a sine wave 720. During periods where the duty cycle of the PWM signal is smaller 730, the output of the analog filtering circuits is a lower voltage 740. When the duty cycle of the digital PWM signal is larger 750, the output of the analog filtering circuits is a higher voltage 760. The less incremental duty cycle steps 730, 750 the PWM signal 710 contains, the more jagged and stair stepped the sine wave 720 output of the analog filters. The better the sine wave 720 approximation, the more intensive the demand on the processor, and the more comfortable the treatment for the patient. Therefore, a PWM system's ability to affect a positive therapeutic experience for the patient is typically limited by the system's processor capabilities.

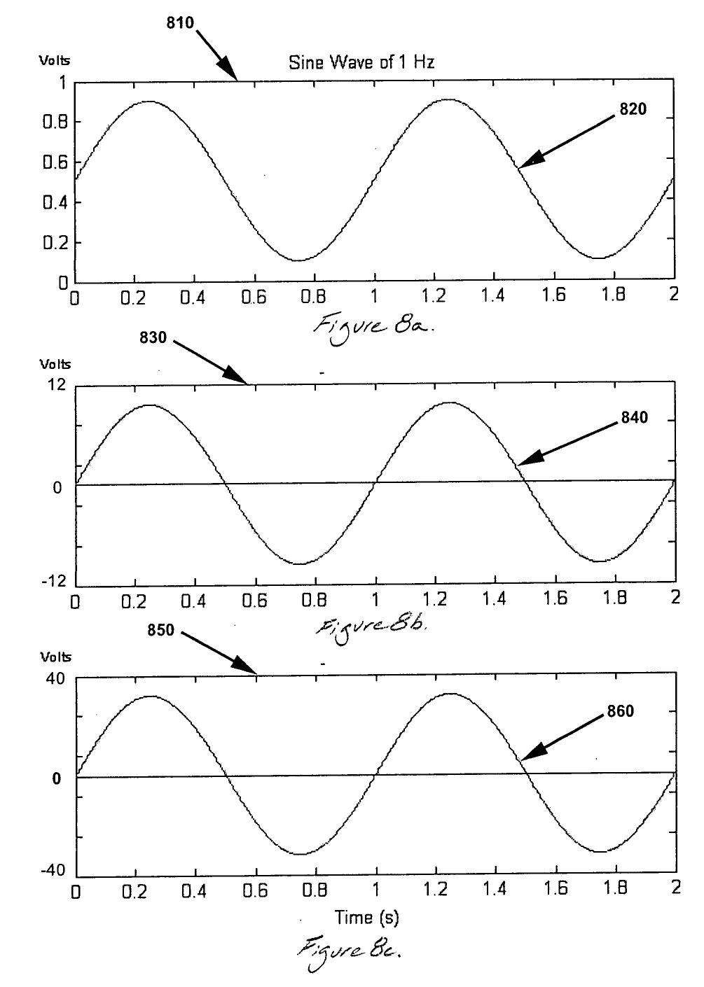

FIG. 8a illustrates sine wave 820 that has emerged from filtering stage 810 as a monophasic waveform (uni-directional). FIG. 8b illustrates the amplification stage 830 of the sine wave 820 from FIG. 8a, in which a negative and positive power source amplifies the signal and converts it to a biphasic waveform (bi-directional) 840. FIG. 8c illustrates the step-up transformer stage 850, wherein a transformer steps-up the voltage of the sine wave 840 shown in FIG. 8b to a level appropriate for electrical stimulation before passing the sine waveform 860 onto a patient's body.

Initially, the filtered sine wave 820 is monophasic, and is low voltage, in order to affect a meaningful therapeutic therapy. This signal is then passed to an amplification stage 830 where it is amplified to a higher voltage. If the sine waveform 820 is to be delivered monophasically, then the amplification stage 830 boosts the signal strength to levels above zero volts. If the sine wave 820 is to be delivered biphasically, the amplification stage 830 boosts the sine wave 820 above and below zero volts, in this example to ±12 volts. With the sufficiently amplified signal 840 generated, a step-up transformer stage 850 performs the final amplification to sufficiently high voltage levels for effective electrical stimulation therapy. The step-up transformer stage 850 increases the voltage at the expense of current, such that the amplification stage 830 generates sufficiently high current levels to suffer the loss. For example, if a ±24 volt signal is to be delivered to the patient at 10 mA, and the step-up transformer stage 850 ratio is 2:1, then the amplification stage 830 generates a ±12 volts signal 840 at a current of 20 mA.

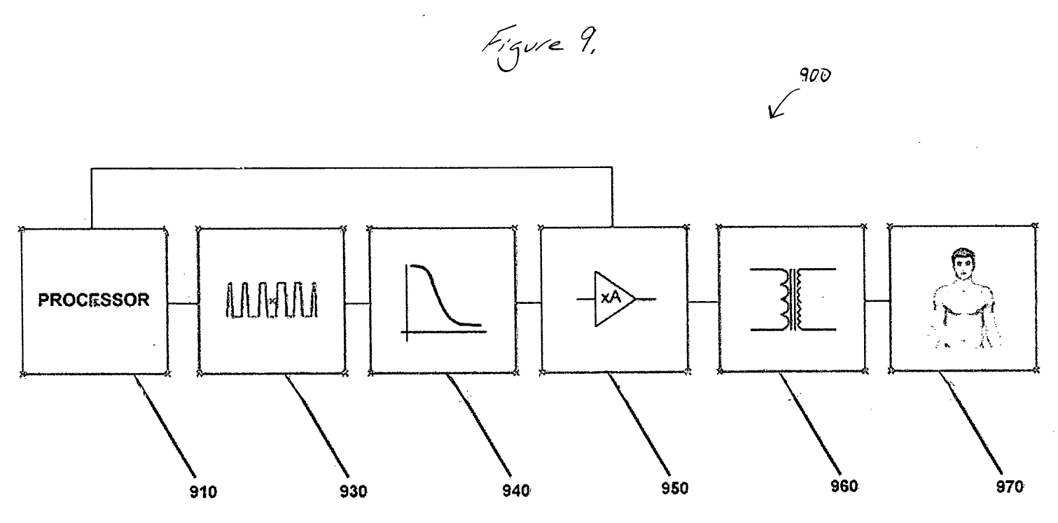

FIG. 9 is a flowchart demonstrating a PWM system 900 for electrical stimulation. The PWM system 900 includes a processor 910, which generates a PWM signal 930 having a sufficient number of duty cycle increases and decreases such that as close an approximation to a sine wave as possible is generated by the analog filtering stages 940. This process is very intensive for the processor 910. Moreover, a PWM system 900 typically will include two channels of stimulation, with each channel delivering two waveforms, which causes the system 900 to be even more processor intensive. Thus either one processor 910 must generate all four PWM signals, or multiple processor 910 circuits are utilized. If the sine wave output delivered to the patient(s) 970 is to be frequency modulated, then the processor(s) 910 also calculates and delivers a PWM signal 930 that accounts for the frequency modulation. The output of the analog filtering circuits 940 is fed through an amplification stage 950. If the sine wave output of the analog filtering circuits 940 is to eventually be delivered to the patient 970 as a pure sine wave without any amplitude modulation, as in the case of Quadripolar Interferential therapy, then the gain of the amplification circuit 950 receives a single command from the processor 910, adjusting the gain one time.

If the amplitude of the sine wave delivered to the patient is to be amplitude modulated, for example at a frequency between 0 and 250 Hz, then the processor 910 communicates commands constantly with the amplification circuit 950 to adjust the gain sinusoidally. The amplitude modulated sine wave is then passed through a step-up transformer stage 960 where the voltage is stepped up one last time to levels sufficiently high for effective electrical stimulation. The output of the step-up transformer stage 960 is finally delivered to the patient 970 to effect treatment.

In a single processor 910 system delivering two channels of dual waveform stimulation, the processor 910 delivers PWM signals 930 to four separate PWM systems 900 simultaneously and constantly if a smooth waveform is to be delivered to the patient. Additionally, if frequency modulation is to be delivered, the processor 910 calculates the appropriate changes in the PWM signal 930 for each system, as either channel may be set independently by the healthcare provider. Further, if amplitude modulation is to be applied to the signal, the processor 910 delivers simultaneous and constant commands to the amplification circuit 950. As either channel and further each waveform of either channel can be adjusted independently, the processor 910 is increasingly burdened.

Another feature of electrical stimulation systems is the ability to vector and rate scan. In vector scanning, which refers to amplitude modulation, a high frequency sine wave is amplitude modulated over a range of therapeutic frequencies typically between 0 and 250 Hz. For example, a 4000 Hz sine wave which is to be amplitude modulated from between 0 and 250 Hz (vector scanning) sinusoidally, would require the processor 910 to generate the PWM signal 930 to generate the carrier frequency, and additionally require the processor 910 to calculate and send constant commands to the amplification circuit scanning the amplitude modulation sinusoidally from 0 Hz up to 250 Hz. If the vector scanning is not smooth, i.e. if it is stepped jaggedly as in the case of stair stepping, then the patient feels discomfort and the effectiveness of the therapy is reduced. In rate scanning, the carrier frequency is frequency-modulated over a frequency range typically between 0 and 250 Hz. This modulation is typically sinusoidal as well, and is required to be smooth, otherwise the patient feels the deleterious effect of a jagged waveform. In the worst case, a single processor 910 is responsible for controlling two separate channels of electrical stimulation, each with two waveforms, or four waveform circuits 900. All waveforms are to be amplitude and frequency modulated, and both vector scanning and rate scanning are indicated. A PWM systems 900 may operate at a carrier frequency of 4000 Hz.

PWM systems may be approved to operate at higher carrier frequencies, for example up to and above 1000 Hz. But a large amount of processor 910 power is required to calculate and send simultaneous and constant communications to both the analog filtering circuits 940 via the PWM signal 930 and to the amplification circuits 950. Further, for the designer of the system 900, the software controlling the device may be difficult, as the processor 910 may handle a user interface, error control, current measurement and feedback loops, and calculates for waveform corrections. Additionally, the system 900 may be limited by the speed and number of processors 910 used to implement it. If the system 900 uses an underpowered processor 910, i.e. not capable of keeping up with the constant demands of the system, various outputs of the electrical stimulation circuit 900 may be adversely affected.

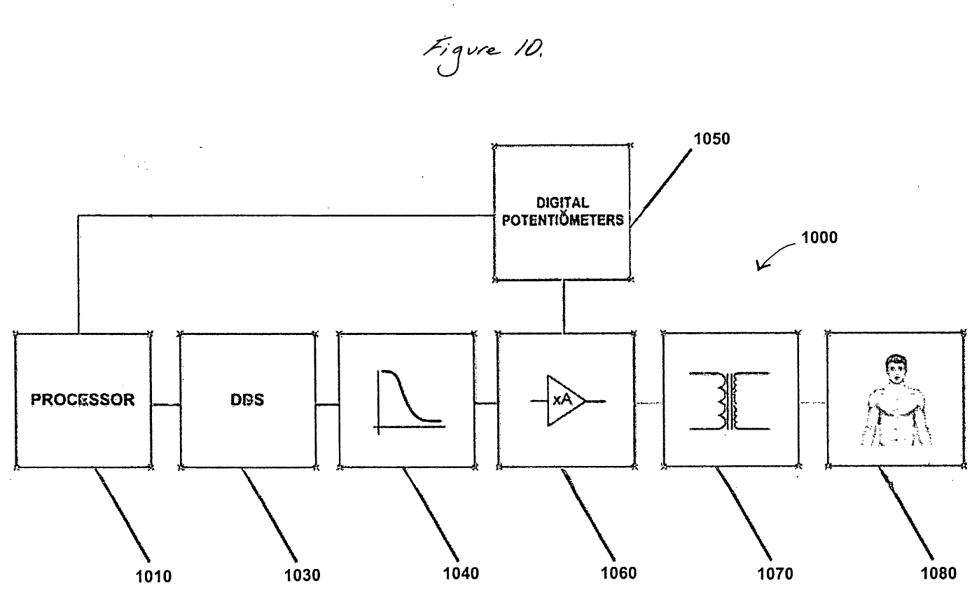

FIG. 10 is a flowchart demonstrating one embodiment of the present invention in which an electrical stimulation waveform generation circuit 1000 utilizes a DDS circuit 1030 to generate initial waveform from a digital word. With the stimulation waveform generation circuit 1000 shown, the processor 1010 communicates a digital word in series or parallel to a DDS circuit 1030. This single digital word instructs the DDS circuit 1030 to generate a waveform at a certain frequency, for example a high frequency that is above 2000 Hz. The DDS circuit 1030 continues to generate this waveform until instructed by the processor 1010 to do otherwise. The DDS circuit 1030 outputs a sine wave which passes through a filtering circuit 1040, which then passes the sine wave through an amplification circuit 1060. The processor 1010 communicates gain information to the amplification circuit 1060. In the case of the generation of a pure sine wave, indicated for Quadripolar Interferential therapy, a single command is required to set the gain of the amplification circuit 1060. In this embodiment 1000, the circuit utilizes digital potentiometers 1050 to control the gain of the amplification circuit 1060. The processor communicates gain information with the digital potentiometers 1050. The amplification stage 1060 passes the amplified waveform through a step-up transformer stage 1070, where the waveform is stepped up to a voltage sufficient for electrical stimulation. The stepped up waveform is then passed to the patient 1080 to affect treatment.

A benefit of the present invention is the significant reduction in the work load for the processor and the complexity of the control software. For example, with a PWM system, the processor calculates and sends a PWM signal constantly and simultaneously to each of the waveform generation circuits. Therefore, if four waveform generators are being utilized, the processor must continuously and simultaneously send a PWM signal to all four waveform generation circuits. Conversely, with the embodiment of the present invention shown in FIG. 10, the processor 1010 sends one command to each DDS circuit, which results in a significant reduction in both the work load for the processor 1010 and the complexity of the control software.

In the case of rate scanning, or sweeping the signal frequency (carrier frequency for a high frequency signal), the DDS circuit 1030 may include automatic sweep generators, such that a single command to the DDS circuit 1030 will both generate and sweep the frequency of the sine wave automatically. Thus, two commands to the DDS circuit 1030 may implement an FM signal that is being rate scanned. In the case of a PWM system, the processor performs complex calculations to vary the PWM signal being delivered to the analog filtering circuits such that an FM signal is generated and also rate scanned. In both PWM systems and this embodiment of the invention illustrated in FIG. 10, the processor 1010 communicates with the amplification circuit at least once as in the case of a constant gain, or many times as in the case of amplitude modulation. However, in the case of the system shown in FIG. 10, the processor is more easily capable of controlling smoothly an amplitude modulation scenario.

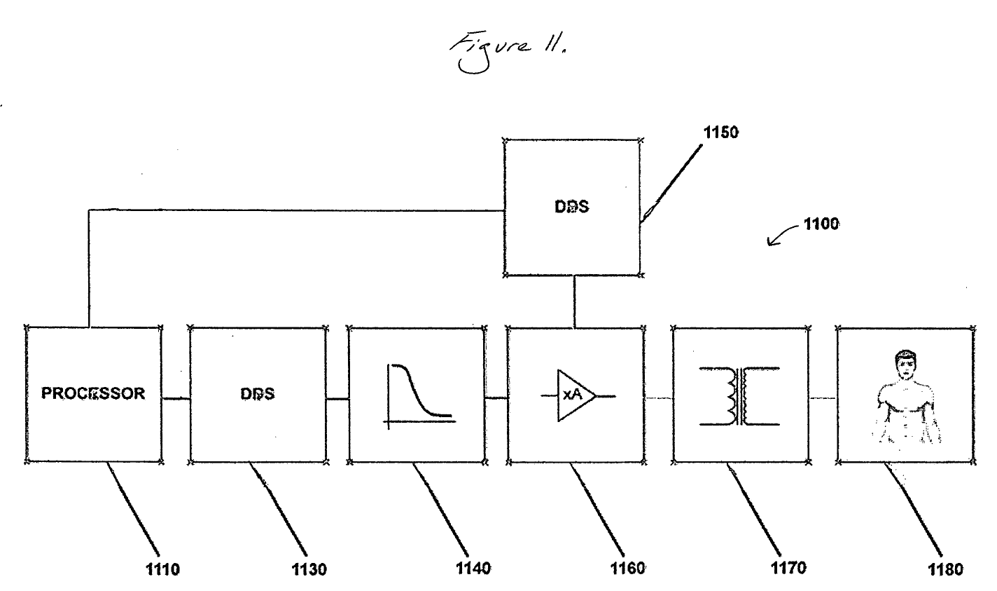

FIG. 11 is a flowchart demonstrating one embodiment of the present invention utilizing a DDS circuit 1130 for wave generation and a DDS circuit 1150 to control the amplification circuit 1160. In the electrical stimulation waveform generation circuit 1100 illustrated in FIG. 11, a processor 1110 communicates a single digital word in series or in parallel to a DDS circuit 1130 setting a frequency, for example a high frequency greater than 2000 Hz, to be output continuously as a sine wave until further instruction is required. The DDS circuit 1130 outputs a sine wave that is passed through a filtering circuit 1140 which is then passed through an amplification circuit 1160.

The processor 1110 also communicates a single digital word to a second DDS circuit 1150 setting an output sine wave at a constant frequency, for example between 0 and 250 Hz, to be output constantly until receiving further instruction. The output of the second DDS circuit 1150 is used to control the gain of the amplification circuit 1160. The amplified sine wave is then passed from the amplification circuit 1160 to the step-up transformer circuit 1170 where the voltage is stepped up to levels sufficient for electrical stimulation therapy. The stepped up sine wave is then passed to the patient 1180 to effect therapy.

The use of two DDS circuits 1130, 1150 in the electrical stimulation waveform generation circuit 1100 shown in FIG. 11 results in a small burden on the processor 1110 with regards to waveform generation. For example, an electrical stimulation device formed on the principles of the present invention may have two channels that each deliver two waveforms, or four waveform generation circuits. Further, all four waveform circuits have different carrier frequencies that are to be rate scanned between 0 and 250 Hz. Additionally, often all four waveforms are amplitude modulated and this AM is to be vector scanned between 0 and 250 Hz. Further, the system 1100 illustrated in FIG. 11 utilizes DDS circuits 1130, 1150 that contain sweep functions.

A single processor 1110 would send four digital words to the four DDS circuits 1130 generating the carrier frequencies for the four waveform circuits. The processor 1110 would then send four digital words to the four DDS circuits 1130 instructing them to sweep the frequency back and forth between 0 and 250 Hz. The processor 1110 would then send four digital words to the four DDS circuits 1150 controlling amplitude modulation via the amplification circuits 1160. Finally, the processor 1110 would send four digital words to the four DDS circuits 1150 controlling amplitude modulation to sweep the amplification frequency from 0 to 250 Hz. A total of 16 digital words would be generated by this complex series of waveforms. And no additional instruction may be required to maintain these waveforms. Further, the outputs of the DDS circuits 1130, 1150, are designed and programmed for precise and controlled sine wave output. Additionally, operating at increasing frequencies, such as 10 kHz, 100 kHz, or 1 MHz, requires no additional work load for the processor 1110.

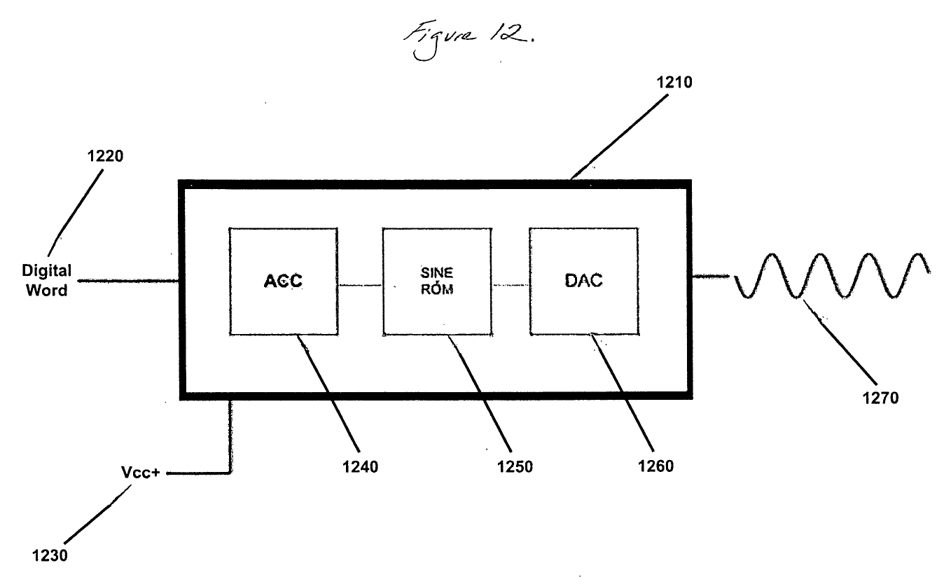

FIG. 12 is a flowchart demonstrating the inner workings of a DDS circuit 1210. The DDS circuit 1210 contains an accumulator 1240, a Sine ROM 1250, and a Digital to Analog (DAC) converter 1260. In this illustration, the DDS circuit 1210 receives power 1230 and processor input 1220 in the form of a digital word in either series or parallel and outputs a sine wave 1270. The DDS circuit 1210 interprets the digital word 1220 as a frequency for an output sine wave 1270. The frequency is set within the DDS circuit 1210 such that the accumulator 1240 counts out a signal which is delivered to the Sine ROM 1250. The Sine ROM is a look-up table of values, for example 4096 values, that define one period of a sine wave. The accumulator 1240 counts out the frequency for which the digitally defined sine wave contained in the Sine ROM 1250 is output to the DAC 1260. The DAC 1260 converts this signal to an output sine wave 1270. The DDS circuit 1210 may also contain internal filtering for smoothing waveforms, and circuitry for controlling sweep frequency functions.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system comprising:
a processor;
a DDS circuit;
a filtering circuit;
a gain loop including a digital potentiometer,
a step-up transformer, and
an electrode pair for creating and delivering electrical stimulation to a patient,
said processor issuing digital words to said DDS circuit, the digital words instructing said DDS circuit to generate a sine waveform at an instructed frequency, said DDS circuit delivers the sine waveform output to said filtering circuit, the filtered waveform being delivered to said gain control loop that receives commands from said processor that change digital potentiometer values and adjust waveform amplitude, the amplitude adjusted waveform being fed through a step-up transformer whose output is fed through wires to said electrode pair that is placed on a patient's body.

2. The invention of claim 1 wherein said DDS circuit includes a sweep generator such than a single command to said DDS circuit from said processor generates and sweeps the frequency of the sine waveform automatically.

3. The invention of claim 1 wherein said DDS circuit includes an accumulator, a Sine ROM, and a Digital to Analog converter, said DDS circuit interpreting the digital words as a frequency for an output sine wave, said accumulator counting out a signal based on information from the digital word, the signal being delivered to said Sine ROM for defining at least one period of the output sine wave, the signal being communicated from said Sine ROM to the said Digital to Analog converter, said Digital to Analog converter converts the signal to the output sine wave.

4. The system of claim 1 wherein the digital words instruct said DDS to generate the sine waveform at a frequency above 2000 Hz.

5. The system of claim 4 wherein said processor communicates the digital words in series to said DDS circuit.

6. The system of claim 4 wherein the processor communicates the digital words in parallel to said DDS circuit.

7. A system comprising:
a processor;
a first DDS circuit;
a filtering circuit;
a gain loop including a second DDS circuit;
a step-up transformer; and
an electrode pair for creating and delivering electrical stimulation to a patient,
said processor issuing digital words to said first DDS circuit, the digital words instructing said first DDS circuit to generate a sine waveform at an instructed frequency, said first DDS circuit delivers the sine waveform output to said filtering circuit, the filtered waveform being delivered to said gain control loop that receives commands from said processor instructing said second DDS circuit to automatically adjust waveform amplitude, the amplitude adjusted waveform being fed through said step-up transformer whose output is fed through wires to said electrode pair positioned on a patient's body.

8. The invention of claim 7 wherein said DDS circuit includes a sweep generator such than a single command to said DDS circuit from said processor generates and sweeps the frequency of the sine waveform automatically.

9. The invention of claim 7 wherein said first DDS circuit includes an accumulator, a Sine ROM, and a Digital to Analog converter, said DDS circuit interpreting the digital words as a frequency for an output sine wave, said accumulator counting out a signal based on information from the digital word, the signal being delivered to said Sine ROM for defining at least one period of the output sine wave, the signal being communicated from said Sine ROM to the said Digital to Analog converter, said Digital to Analog converter converts the signal to the output sine wave.

10. The system of claim 7 wherein the digital words instruct said DDS to generate the sine waveform at a frequency above 2000 Hz.

11. The system of claim 8 wherein said processor communicates the digital words in series to said DDS circuit.

12. The system of claim 8 wherein the processor communicates the digital words in parallel to said DDS circuit.

13. A method for generating electrical stimulation waveforms comprising the steps of:
a. issuing at least one digital word from a processor to a first DDS circuit, the at least one digital word instructing said first DDS circuit to generate a sine waveform at an instructed frequency;
b. filtering the sine waveform through a filtering circuit, the filtering circuit outputting a filtered sine waveform;
c. adjusting the amplitude of the filtered sine waveform.
d. feeding the amplitude adjusted filtered sine waveform through a step-up transformer wherein the voltage of the amplitude adjusted filtered waveform is stepped up to levels sufficient for electrical stimulation therapy; and
e. passing the amplitude adjusted filtered sine waveform outputted from the step-up transformer to an electrode pair positioned on a patient's body.

14. The method of claim 13 wherein the step of adjusting the amplitude of the filtered sine waveform includes the delivering commands from the processor to a gain control loop instructing a second DDS circuit to automatically adjust waveform amplitude.

15. The method of claim 13 wherein the step of adjusting the amplitude of the filtered sine waveform includes the delivering commands from the processor to a gain control loop that change digital potentiometer values and adjust waveform amplitude.
